(19) United States
(12) Patent Application Publication
(10) Pub. No.: US 2011/0127743 A1
(43) Pub. Date: Jun. 2, 2011

(54) TAILORED BLANK MATERIAL AND METHOD OF MANUFACTURING STRUCTURAL MEMBER USING THE SAME

(75) Inventor: Ayaka Musha, Aichi-ken (JP)

(73) Assignee: TOYOTA JIDOSHA KABUSHIKI KAISHA, AICHI-KEN (JP)

(21) Appl. No.: 12/677,222

(22) PCT Filed: May 8, 2009
(86) PCT No.: PCT/JP09/02030

§ 371 Date: Mar. 9, 2010

(51) Int. Cl. B60G 7/00; B23K 31/02

(52) U.S. Cl. 280/124.1; 228/173.1

(57) ABSTRACT

A tailored blank material 10 is configured by welding a plurality of steel plates 12, 14, and 16. At least one steel plate 12 among the plurality of steel plates 12, 14 and 16 is welded to other steel plates 14 and 16 so that the rolling direction 12a thereof differs from the rolling directions 14a and 16a of the other steel plates 14 and 16. Thickness of at least one steel plate among the plurality of steel plates 12, 14, and 16 may differ from thickness of other steel plates.

### FIELD OF THE INVENTION

The present invention relates to a tailored blank material, and in particular, relates to a tailored blank material which is favorable to a structural member such as a suspension arm.

### DESCRIPTION OF THE RELATED ART

Recently, structural members used for automobiles and the like have been desired to be further lightened while maintaining required strength. Further, required performance for one structural member is becoming more diverse year by year. Accordingly, there is a case that the required characteristics remarkably vary corresponding to portions. In the case that such a structural member is processed and manufactured with a single member (i.e., a single material), normally, the thickness and shape thereof are determined based on a portion receiving the largest stress or a portion requiring the highest level of characteristics. As a result, a structural member with excessive strength or characteristics in part is to be manufactured.

Accordingly, tailored blank materials have been developed as press materials formed by joining a plurality of steel plates with welding to serve purposes. For example, it has been studied to adopt the tailored blank material as a sub-frame of a chassis of an automobile in view of decreasing automobile body weight and increasing automobile body strength. Patent document 1 discloses a welding structural member in which stress concentration of a welding portion is to be loosened by arranging notches near the welding portion between tailored blank materials.
[Patent document 1] Japanese Patent Application Laid-open No. 2006-306211
[Patent document 2] Japanese Patent Application Laid-open No. 10-175027
[Patent document 3] Japanese Patent Application Laid-open No. 2000-290749

### DISCLOSURE OF THE INVENTION

### Problems to be Solved by the Invention

As described above, structural members used for automobiles and the like are desired to satisfy both required strength and lightening. In order to achieve lightening, it may be considered to reduce member thickness by using a high strength material. However, in general, high strength materials have been desired to be improved in view of processing easiness due to poor extension thereof. In particular, for example, since a component such as a suspension arm used for an automobile is complicated in shape, it is difficult to perform forming in high accuracy by deep drawing and the like using such a high-strength material as the material for such a component.

The present invention is revised in view of the abovementioned situation to provide a tailored blank material having excellent formability.

### Means for Solving the Problems

To address this issue, a tailored blank material according to a first aspect of the present invention is configured by welding a plurality of rolling members, and at least one rolling member among the plurality of rolling members is welded with another rolling member so that the rolling direction of the rolling member is different from the rolling direction of the other rolling member.

According to the first aspect, by considering the rolling directions of the plurality of rolling members to be welded, excellent formability can be obtained in the subsequent forming process, such as drawing and bending, even in a case that a structural member manufactured by forming, for example, has a complicated shape with the deformation directions and deformation amounts being different from portion to portion.

Here, at least one rolling member among the plurality of rolling members may be formed so that the thickness of the rolling member is different from that of another rolling member. Thus, the rolling member corresponding to a portion requiring relatively small strength and having a smaller deformation amount by forming than that of another portion may be thinned, while the rolling member corresponding to a portion of a complicated shape requiring relatively large strength and having a large deformation amount may be thickened. In this manner, it becomes possible to manufacture a structural member which satisfies both strength and lightening at a high level.

At least one rolling member among the plurality of rolling members may be formed of material being different from that of another rolling member. Accordingly, by selecting the material of the rolling member appropriately for each of portions having different required strength and deformation amounts, it becomes possible to manufacture a structural member which satisfies both strength and lightening at a high level.

According to a second aspect of the present invention, a manufacturing method of a structural member using a tailored blank material which is configured by welding a plurality of rolling members includes a step of preparing a tailored blank material which is welded so that a rolling direction of at least one rolling member among the plurality of rolling members is different from a rolling direction of another rolling member, and a step of forming the tailored blank material so that a deformation amount in the rolling direction is to be larger than a deformation amount in a direction crossing the rolling direction for each of the plurality of rolling members.

According to the second aspect, a structural member can be manufactured without decreasing formability even with different required characteristic and deformation amounts at the time of forming for each portion.

### Effect of the Invention

Accordingly, the present invention can provide a tailored blank material having excellent formability.

### BRIEF DESCRIPTION OF THE DRAWINGS

FIG. 1 is a schematic top view which illustrates a tailored blank material used for manufacturing a structural member according to an embodiment.

FIG. 2 is a perspective view which illustrates a suspension arm using the structural member according to the present embodiment.

FIG. 3(a) is a sectional view at A-A of the suspension arm in FIG. 2, FIG. 3(b) is a sectional view at B-B of the suspension arm in FIG. 2, and FIG. 3(c) is a sectional view at C-C of the suspension arm in FIG. 2.

### BEST MODE FOR CARRYING OUT THE INVENTION

In the following, embodiments of the present invention will be described in detail with reference to the drawings.

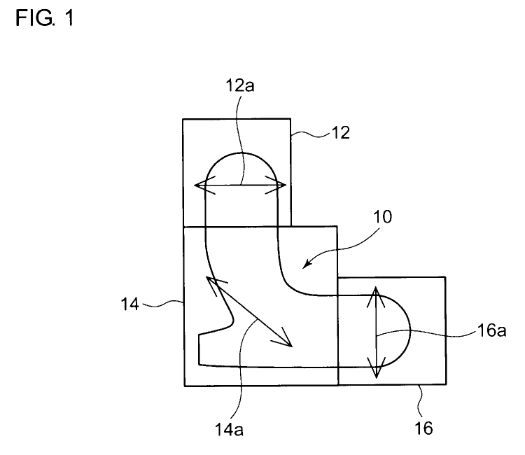

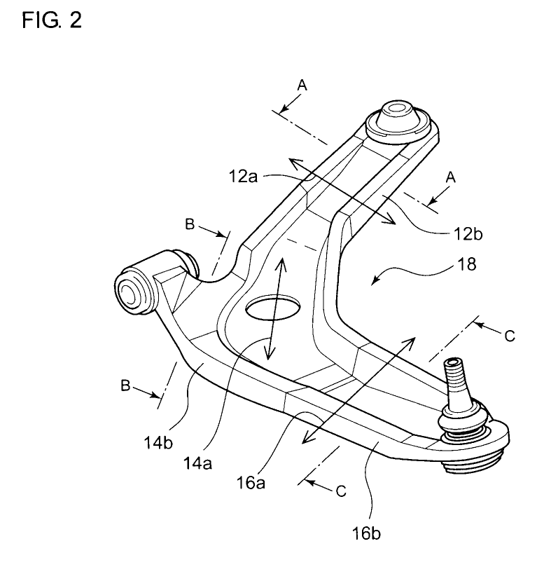

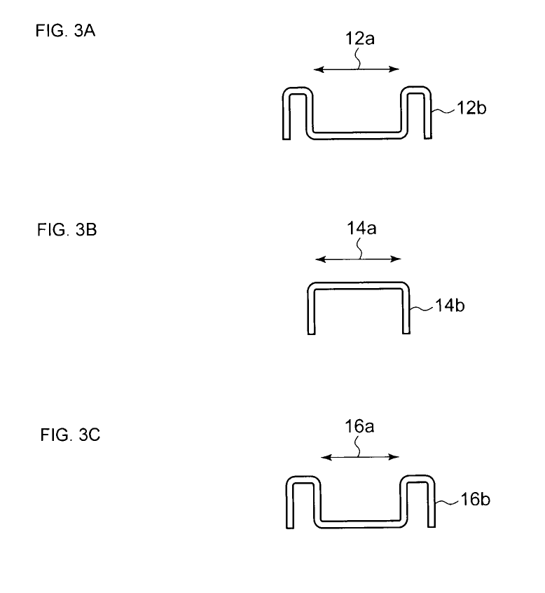

FIG. 1 is a schematic top view which illustrates a tailored blank material used for manufacturing a structural member according to an embodiment. FIG. 2 is a perspective view which illustrates a suspension arm using the structural member according to the present embodiment. FIG. 3(a) is a sectional view at A-A of the suspension arm in FIG. 2, FIG. 3(b) is a sectional view at B-B of the suspension arm in FIG. 2, and FIG. 3(c) is a sectional view at C-C of the suspension arm in FIG. 2.

As illustrated in FIG. 1, the tailored blank material 10 according to the present embodiment is formed by respectively welding three plate-shaped steel plates 12, 14, and 16 and removing excessive portions in consideration of a shape of the formed suspension arm. The steel plates 12, 14, and 16 are welded so that respective rolling directions 12a, 14a, and 16a are different from one another. A high strength steel plate for automobiles (so-called high-ten) is preferable as the steel plate. Thickness of the steel plates 12, 14, and 16 may be appropriately set depending on usage of the formed structural member. The lightening, strength and formability can be satisfied together as long as the thickness is within a range of 1 to 10 mm, preferably within a range of 2 to 5 mm, for example.

In the case that the abovementioned high strength steel plate is used as the steel plate, the plate thickness can be reduced while ensuring the desired strength. However, there remains some room for improvement of the formability at a deep-drawing portion in drawing processing, for example. This is because the high strength steel plate is not suitable for processing which accompanies locally large deformation such as drawing processing since extension (i.e., the deformation amount) of the high strength steel plate is smaller than that of a normal steel plate.

Here, the steel plates 12, 14, and 16 constituting the tailored blank material according to the present embodiment are rolling members. Accordingly, in the state that the same stress is applied in various directions, the deformation amount in the rolled direction (i.e., the rolling direction) is larger than the deformation amount in the direction crossing the rolled direction in respective steel plates. Therefore, by considering the rolling directions 12a, 14a, and 16a of the plurality of steel plates 12, 14, and 16 to be welded, excellent formability can be obtained in the subsequent forming process, such as drawing and bending, even in a case that the structural member manufactured by forming, for example, has a complicated shape with the deformation directions and deformation amounts being different from portion to portion.

In the following, a lower arm used for a front suspension of an automobile will be specifically described as an example of the structural member manufactured using the abovementioned tailored blank material.

In the present embodiment, the tailored blank material 10 as illustrated in FIG. 1 is prepared, and then, the forming of drawing or bending is performed with a die which is machined corresponding to the shape of the lower arm. As illustrated in FIG. 2, in the lower arm 18, the steel plates 12, 14, and 16 respectively have difference in shape and deformation amount for each of the formed portions 12b, 14b, and 16b. Specifically, in the forming process according to the present embodiment, the tailored blank material 10 is formed so that the deformation amount in the rolling direction is to be larger than the deformation amount in the direction crossing the rolling direction for each of the plurality of steel plates.

In the lower arm 18, the direction having the largest deformation amount at the portion 12b of FIG. 2 is approximately the same direction as the rolling direction 12a indicated in FIG. 3(a). Thus, since the tailored blank material 10 is to be deformed easier in the same direction as the rolling direction 12a than other directions, forming can be performed in high accuracy. As a result, even in the case that the high strength material of the degree to satisfy the desired strength is used as the material of the steel plates, thinning and lightening can be simultaneously achieved since sufficient formability can be ensured. Here, as illustrated in FIGS. 3(b) and 3(c), the direction of a large deformation amount at the time of forming is also approximately the same as the rolling direction 14a and 16a for the other portion 14b and 16b of the lower arm 18.

Here, in the abovementioned tailored blank material 10, the steel plates 12, 14, and 16 are not limited to have the same thickness. The thickness of at least one steel plate among the plurality of steel plates may be different from the thickness of another steel plate. Accordingly, the tailored blank material is formed by thinning the steel plate corresponding to a portion which requires relatively small strength or has a smaller deformation amount by forming than that of another portion and by thickening the steel plate corresponding to a portion which requires strength or has a complicated shape with large deformation amount by forming. In this manner, the lower arm can be manufactured to satisfy both strength and lightening at a high level. In other words, by using the tailored blank material according to the present embodiment, a structural member can be manufactured without decreasing formability even with different required strength and deformation amounts at the time of forming for each portion.

As described above, in the case of manufacturing a structural member such as a suspension arm by using the tailored blank material according to the present embodiment, the welding direction of each steel plate constituting the tailored blank material may be determined in consideration of the arm shape and the rolling direction having excellent formability, namely, capable of being deformed relatively easily. That is, by matching the rolling direction of the steel plate with the direction having the largest deformation at the time of forming, the formability can be ensured even when the high strength material is used for lightening, for example. In this manner, by welding the plurality of steel plates of which rolling directions are to be different, both strength and lightening of the structural member such as the suspension arm can be satisfied.

In the above, the present invention is described with reference to the abovementioned embodiment. However, not limited to the abovementioned embodiment, the present invention includes the configuration with appropriate combination or replacement of the embodiment. Further, it is also possible that combination or order of processes of the embodiment is appropriately changed and modification such as various design changes and the like is added to the embodiment based on knowledge of a skilled person in the art. The present invention can include the embodiment to which such a modification is added.

Here, the number of the rolling members constituting the tailored blank material is not limited to three as the present embodiment. Any number may be adopted as long as being two or more. The number, size and thickness of the rolling members constituting the tailored blank material may be appropriately selected in consideration of the subsequent forming method and the structural member to be manufactured. Further, the material is not necessarily the same for all of the rolling members constituting the tailored blank material. It is also possible to appropriately combine rolling members of different materials in consideration of deformation at the time of forming and required strength.

### DESCRIPTION OF REFERENCE NUMERALS

10 tailored blank material, 12 steel plate, 12a rolling direction, 14 steel plate, 14a rolling direction, 16 steel plate, 16a rolling direction, 18 lower arm

1. A tailored blank material which is configured by welding a plurality of rolling members, wherein
at least one rolling member among the plurality of rolling members is welded with another rolling member so that the rolling direction of the rolling member is different from the rolling direction of the other rolling member.

2. The tailored blank material according to claim 1, wherein
thickness of at least one rolling member among the plurality of rolling members is different from thickness of another rolling member.

3. The tailored blank material according to claim 1, wherein
material of at least one rolling member among the plurality of rolling members is different from material of another rolling member.

4. A method of manufacturing a structural member using a tailored blank material which is configured by welding a plurality of rolling members, comprising the steps of:
preparing a tailored blank material which is welded so that a rolling direction of at least one rolling member among the plurality of rolling members is different from a rolling direction of another rolling member; and
forming the tailored blank material so that a deformation amount in the rolling direction is to be larger than a deformation amount in a direction crossing the rolling direction for each of the plurality of rolling members.

5. The tailored blank material according to claim 2, wherein
material of at least one rolling member among the plurality of rolling members is different from material of another rolling member.
